(19) United States
(12) Patent Application Publication
(10) Pub. No.: US 2025/0375336 A1
(43) Pub. Date: Dec. 11, 2025

(54) WORKBENCH CONTROL ASSEMBLY, WORKBENCH WATERWAY INTEGRATED SYSTEM AND DENTAL NURSE WORKBENCH

(71) Applicant: Guangdong JINME Medical Technology Co., Ltd., Foshan (CN)

(72) Inventors: Xihua CAO, Foshan (CN); Huajun LI, Foshan (CN); Hua WANG, Foshan (CN); Chongyi XU, Foshan (CN); Zihao CHEN, Foshan (CN)

(73) Assignee: Guangdong JINME Medical Technology Co., Ltd., Foshan (CN)

(21) Appl. No.: 19/014,725

(22) Filed: Jan. 9, 2025

(30) Foreign Application Priority Data
Jun. 7, 2024 (CN) 202410736411.0
Jun. 7, 2024 (CN) 202410736414.4

(51) Int. Cl. A61G 15/16; A61C 1/00; A61C 17/06; A61C 17/12; A61C 17/14

(52) U.S. Cl. CPC A61G 15/16; A61C 1/0015; A61C 17/065; A61C 17/12; A61C 17/14

(57) ABSTRACT

Disclosed are a workbench control assembly, a workbench waterway integrated system and a dental nurse workbench. The workbench control assembly includes a cleaning assembly, a spittoon, a saliva suction assembly, a sewage container, a first conveying assembly and a second conveying assembly. The spittoon is connected to the cleaning assembly and configured to receive mouth rinse wastewater, the saliva suction assembly is configured to contact oral sewage or connect to the cleaning assembly, the sewage container is connected to the spittoon and the saliva suction assembly, the first conveying assembly is connected to the cleaning assembly and configured to convey a cleaning liquid supplied by the cleaning assembly to the spittoon and the saliva suction assembly respectively, and the second conveying assembly is connected to the sewage container and configured to convey a mixed liquid conveyed to the spittoon and the saliva suction assembly to the sewage container.

### CROSS-REFERENCE TO RELATED APPLICATIONS

The present application claims priority to Chinese Patent Application No. 202410736414.4, filed on Jun. 7, 2024, and Chinese Patent Application No. 202410736411.0, filed on Jun. 7, 2024, the entire contents of which are incorporated herein by reference.

### TECHNICAL FIELD

The present application relates to the technical field of medical equipment, and in particular to a workbench control assembly, a workbench waterway integrated system and a dental nurse workbench.

### BACKGROUND

Teeth in the human body, with prolonged use, may suffer from damage or even loss. In such cases, and dental implants are required. Dental implantation, also known as tooth planting, refers to the process of in which a biocompatible material, such as pure titanium, is designed and manufactured into a shape resembling a tooth root, such as cylinders, and then surgically implanted into the jawbone to serve as an artificial tooth root. Subsequently, a dental crown is fabricated and placed on the artificial root.

During the process of dental implantation and other operations, various types of wastewater are generated, such as oral sewage from patients and mouth rinse wastewater. This wastewater contains not only large amounts of bacteria, viruses, and other pathogenic microorganisms, but also may include chemical agents and fine particles from decayed teeth. These need to be promptly handled by healthcare workers. However, existing dental equipment lacks a control system capable of orderly efficiently collecting, cleaning, and discharging the wastewater in an organized manner. Currently, the treatment of wastewater still largely depends on manual methods, which is inefficient and increases the risk of healthcare workers coming into contact with harmful substances in the wastewater.

### SUMMARY

The main objective of the present application is to provide a workbench control assembly, a workbench waterway integrated system and a dental nurse workbench, which aims to complete a series of tasks such as orderly efficiently collecting, cleaning and discharging the wastewater generated during operations of the dental implants.

In order to achieve the above objective, the present application provides a workbench control assembly, including a cleaning assembly configured to supply a cleaning liquid, a spittoon connected to the cleaning assembly, a saliva suction assembly configured to contact oral sewage or connect to the cleaning assembly, a sewage container connected to the spittoon and the saliva suction assembly, a first conveying assembly connected to the cleaning assembly, and a second conveying assembly connected to the sewage container.

In an embodiment, the spittoon is configured to receive mouth rinse wastewater.

In an embodiment, when the saliva suction assembly is connected to the cleaning assembly, the first conveying assembly is configured to convey the cleaning liquid supplied by the cleaning assembly to the spittoon and the saliva suction assembly respectively.

In an embodiment, when the saliva suction assembly contacts the oral sewage, the second conveying assembly is configured to convey the oral sewage at the saliva suction assembly to the sewage container, and when the saliva suction assembly is connected to the cleaning assembly, the second conveying assembly is configured to convey a mixed liquid conveyed to the spittoon and the saliva suction assembly to the sewage container.

In an embodiment, the cleaning assembly includes cleaning container and an external liquid supply pipeline, the cleaning container is in communication with the external liquid supply pipeline, the cleaning container is connected to the spittoon, the saliva suction assembly is in communication with the external liquid supply pipeline, and the cleaning container is configured to store the cleaning liquid.

In an embodiment, the external liquid supply pipeline includes a first pipe and a second pipe, a first end of the first pipe is connected to an external tap water supply, a second end of the first pipe is in communication with the cleaning container, a first end of the second pipe is connected to the external tap water supply and/or the cleaning container, and a second end of the second pipe is connected to the saliva suction assembly.

In an embodiment, the cleaning container is connected to the spittoon through a first suction pump, and a first valve is arranged at a connecting channel between the spittoon and the sewage container;
the workbench control assembly further includes a main control module, the main control module is electrically connected to the first suction pump and the first valve;
the main control module is configured to simultaneously send a first opening signal to the first suction pump and the first valve when receiving an external sewage discharge instruction;
the first suction pump is configured to perform a suction operation to suck the cleaning liquid in the cleaning container into the spittoon when receiving the first opening signal; and
the first valve is configured to open when receiving the first opening signal.

In an embodiment, the saliva suction assembly is provided with a first trigger switch, the workbench control assembly further includes a main control module, the main control module is electrically connected to the first trigger switch and the second conveying assembly;
when the first trigger switch changes from a state of not being affected by an external action to a state of being affected by the external action, the first trigger switch is configured to send a first trigger signal to the main control module, or when the first trigger switch changes from a state of being affected by an external action to a state of not being affected by the external action, the first trigger switch is configured to send a second trigger signal to the main control module;
the main control module is configured to send a first stop signal to the second conveying assembly when receiving the first trigger signal, and the main control module is configured to send a first start signal to the second conveying assembly when receiving the second trigger signal; and
the second conveying assembly is configured to stop conveying the oral sewage at the saliva suction assembly to the sewage container when receiving the first stop signal, and the second conveying assembly is configured to start conveying the oral sewage at the saliva suction assembly to the sewage container when receiving the first start signal.

In an embodiment, the sewage container is provided with a water volume sensing device electrically connected to the main control module;
the main control module is configured to send a water volume detection signal to the water volume sensing device when receiving the second trigger signal;
the water volume sensing device is configured to start obtaining a real-time sewage volume in the sewage container when receiving the water volume detection signal, and the water volume sensing device is configured to send a water volume indication signal to the main control module when the real-time sewage volume reaches a preset water volume threshold;
the main control module is configured to perform an alarm operation or send a second stop signal to the second conveying assembly when receiving the water volume indication signal; and
the second conveying assembly is configured to stop conveying the oral sewage at the saliva suction assembly to the sewage container when receiving the second stop signal.

In an embodiment, the sewage container is provided with a pressure sensing device electrically connected to the main control module;
the main control module is configured to send a pressure detection signal to the pressure sensing device when receiving the second trigger signal;
the pressure sensing device is configured to start obtaining a negative pressure value in the sewage container when receiving the pressure detection signal, and the pressure sensing device is configured to send a pressure indication signal to the main control module when the negative pressure value reaches a preset pressure threshold;
the main control module is configured to perform an alarm operation or send a third stop signal to the second conveying assembly when receiving the pressure indication signal; and
the second conveying assembly is configured to stop conveying the oral sewage at the saliva suction assembly to the sewage container when receiving the third stop signal.

In an embodiment, a sewage discharge end of the sewage container is connected to a sewage discharge pipe, a second valve is arranged in the sewage discharge pipe, a second trigger switch is arranged at the sewage discharge pipe, and the main control module is electrically connected to the second valve and the second trigger switch;
when the second trigger switch changes from a state of not being affected by an external action to a state of being affected by the external action, the second trigger switch is configured to send a third trigger signal to the main control module, or when the second trigger switch changes from a state of being affected by an external action to a state of not being affected by the external action, the second trigger switch is configured to send a fourth trigger signal to the main control module;
the main control module is configured to send a first closing signal to the second valve when receiving the third trigger signal, and the main control module is configured to send a second opening signal to the second valve when receiving the fourth trigger signal; and
the second valve is configured to close when receiving the first closing signal, and the second valve is configured to open when receiving the second opening signal.

In an embodiment, the main control module is configured to send a second closing signal to the second valve when receiving the second trigger signal, and the second valve is configured to close when receiving the second closing signal.

The present application provides a workbench waterway integrated system, including a sewage container, a spittoon configured to receive mouth rinse wastewater, a cleaning container, and a saliva suction assembly.

In an embodiment, a sewage discharge end of the sewage container is in communication with an external sewage discharge area.

In an embodiment, a liquid discharge port of the spittoon is in communication with a first liquid collection end of the sewage container.

In an embodiment, a replenishment end of the cleaning container is in communication with an external liquid supply pipeline, a liquid supply end of the cleaning container is in communication with a liquid inlet of the spittoon, and the cleaning container is configured to supply a cleaning liquid to the spittoon to clean the spittoon.

In an embodiment, a liquid discharge end of the saliva suction assembly is in communication with a second liquid collection end of the sewage container, and a liquid inlet end of the saliva suction assembly is configured to suck oral sewage or to be in communication with the external liquid supply pipeline.

In an embodiment, a plurality of the liquid inlets are arranged at the spittoon, the plurality of the liquid inlets are circumferentially arranged around an upper side of the spittoon, and the liquid discharge port is arranged at a bottom of the spittoon; and/or
the saliva suction assembly includes a strong tip and a weak tip, and the workbench waterway integrated system further includes a tee fitting, a first connection end of the tee fitting is in communication with the strong tip, a second connection end of the tee fitting is in communication with the weak tip, and a third connection end of the tee fitting is in communication with the second liquid collection end of the sewage container.

In an embodiment, the external liquid supply pipeline includes a first pipe and a second pipe, a first end of the first pipe is connected to an external tap water supply, a second end of the first pipe is in communication with the replenishment end of the cleaning container, a first end of the second pipe is connected to the external tap water supply and/or the liquid supply end of the cleaning container, and a second end of the second pipe is in communication with a liquid inlet end of the saliva suction assembly.

In an embodiment, the workbench waterway integrated system also includes a negative pressure assembly, the negative pressure assembly is in communication with a negative pressure end of the sewage container, the negative pressure assembly is configured to generate a negative pressure inside the sewage container, so as to uniformly suck external mixed liquid into an inner cavity of the sewage container through the first liquid collection end and the second liquid collection end.

In an embodiment, the saliva suction assembly is provided with a first trigger switch electrically connected to the negative pressure assembly;
when the first trigger switch changes from a state of not being affected by an external action to a state of being affected by the external action, the first trigger switch is configured to send a first closing signal to the negative pressure assembly, or when the first trigger switch changes from a state of being affected by an external action to a state of not being affected by the external action, the first trigger switch is configured to send a first opening signal to the negative pressure assembly; and
the negative pressure assembly is configured to exit a negative pressure working state when receiving the first closing signal, and the negative pressure assembly is configured to enter the negative pressure working state when receiving the first opening signal.

In an embodiment, the sewage container is provided with a water volume sensing device electrically connected to the negative pressure assembly;
the water volume sensing device is configured to obtain a real-time sewage volume in the sewage container, and the water volume sensing device is configured to send a stop signal to the negative pressure assembly when the real-time sewage volume reaches a preset water volume threshold; and
the negative pressure assembly is configured to stop the negative pressure operation when receiving the stop signal.

In an embodiment, the liquid supply end of the cleaning container is connected to the liquid inlet of the spittoon through a first suction pump, and a first valve is arranged at a connection pipe between the liquid discharge port of the spittoon and the first liquid collection end of the sewage container;
the workbench waterway integrated system further includes a control switch, the control switch is electrically connected to the first suction pump and the first valve;
the control switch is configured to simultaneously send a second opening signal to the first suction pump and the first valve when receiving an external sewage discharge instruction;
the first suction pump is configured to perform a suction operation to suck the cleaning liquid in the cleaning container into the spittoon when receiving the second opening signal; and
the first valve is configured to open when receiving the second opening signal.

In an embodiment, the workbench waterway integrated system also includes an adapter, the adapter is configured to lock on a fixed housing, a first end of the adapter forms a quick-connect interface, the liquid inlet end of the saliva suction assembly is configured to be plugged into a first end of the adapter, and a second end of the adapter is in communication with the external liquid supply pipeline.

In an embodiment, a sewage discharge end of the sewage container is connected to a sewage discharge pipe, a second valve is arranged in the sewage discharge pipe, a second trigger switch is arranged at the sewage discharge pipe, and the second trigger switch is electrically connected to the second valve;
when the second trigger switch changes from a state of not being affected by an external action to a state of being affected by the external action, the second trigger switch is configured to send a second closing signal to the second valve, or when the second trigger switch changes from a state of being affected by an external action to a state of not being affected by the external action, the second trigger switch is configured to send a third opening signal to the second valve; and
the second valve is configured to close when receiving the second closing signal, and the second valve is configured to open when receiving the third opening signal.

The present application provides a dental nurse workbench, the dental nurse workbench includes the workstation control assembly as described above.

The present application provides a dental nurse workbench, the dental nurse workbench includes the workbench waterway integrated system as described above.

The technical solution of the present application, through the rational arrangement of the cleaning assembly, the spittoon, the saliva suction assembly and the sewage container, can orderly accomplish a series of tasks such as unified collection of sewage, cleaning of devices, and centralized sewage discharge through the liquid transfer operations between various components by using the first conveying assembly and the second conveying assembly. Moreover, the operations do not interfere with each other, thereby improving the sewage discharge efficiency and reducing the risk of direct contact between healthcare workers and harmful substances in the sewage.

### BRIEF DESCRIPTION OF THE DRAWINGS

In order to more clearly illustrate the technical solutions in the embodiments of the present disclosure or in the related art, drawings used in the embodiments or in the related art will be briefly described below. Obviously, the drawings in the following description are only some embodiments of the present disclosure. It will be apparent to those skilled in the art that other figures can be obtained according to the structures shown in the drawings without creative work.

FIG. 1 is a connection diagram of a workbench control assembly according to an embodiment of the present application.

FIG. 2 is a connection diagram of a workbench control assembly according to another embodiment of the present application.

FIG. 3 is a schematic diagram of the overall structure of a dental nurse workbench according to an embodiment of the present application.

FIG. 4 is a connection diagram of a workbench waterway integrated system according to an embodiment of the present application.

FIG. 5 is a connection diagram of a workbench waterway integrated system according to another embodiment of the present application.

The realization of the objective, functional characteristics, and advantages of the present disclosure are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

During the process of dental implantation and other operations, various types of wastewater are generated, such as oral sewage from patients and mouth rinse wastewater. This wastewater contains not only large amounts of bacteria, viruses, and other pathogenic microorganisms, but also may include chemical agents and fine particles from decayed teeth. These need to be promptly handled by healthcare workers. However, existing dental equipment lacks a control system capable of orderly efficiently collecting, cleaning, and discharging the wastewater in an organized manner. Currently, the treatment of wastewater still largely depends on manual methods, which is inefficient and increases the risk of healthcare workers coming into contact with harmful substances in the wastewater.

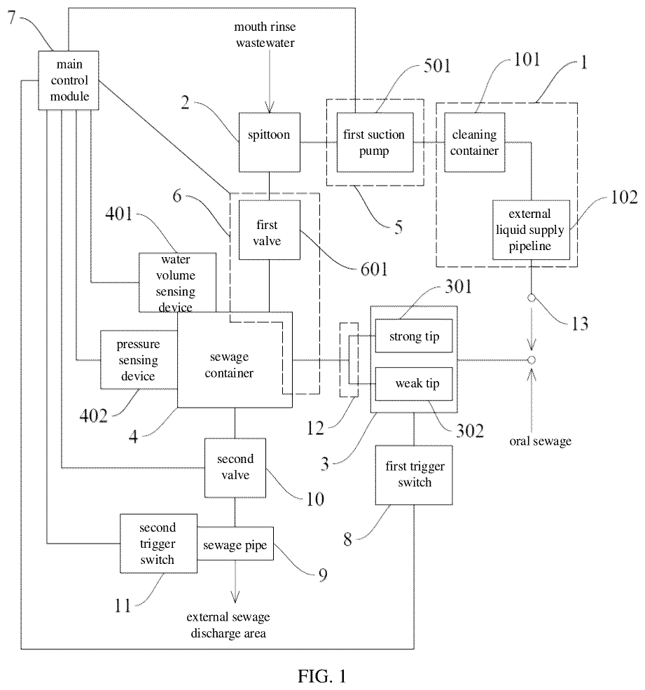

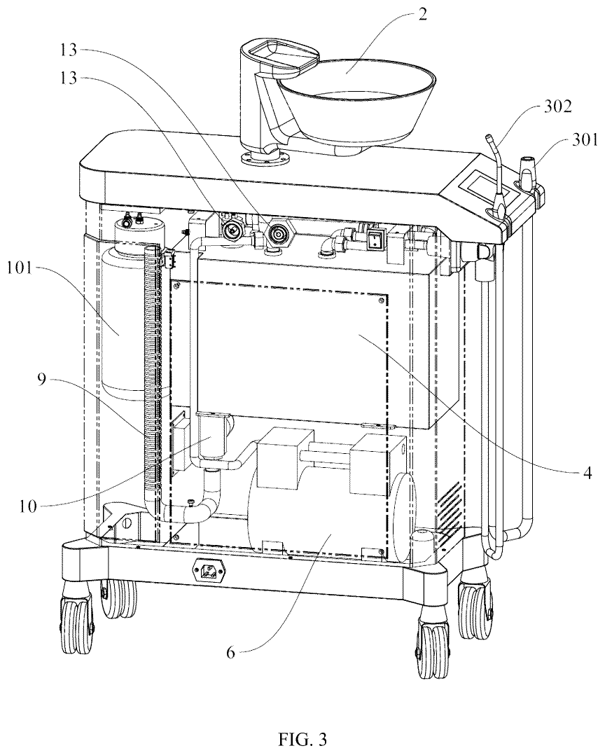

In order to solve the above problems, the present application provides a workbench control assembly, referring to FIG. 1 and FIG. 3, the workbench control assembly includes a cleaning assembly 1, a spittoon 2, a saliva suction assembly 3, a sewage container 4, a first conveying assembly 5 and a second conveying assembly 6. The cleaning assembly 1 is configured to supply a cleaning liquid. The spittoon 2 is connected to the cleaning assembly 1, and the spittoon 2 is configured to receive mouth rinse wastewater. The saliva suction assembly 3 is configured to contact oral sewage or connect to the cleaning assembly 1. The sewage container 4 is connected to the spittoon 2 and the saliva suction assembly 3. The first conveying assembly 5 is connected to the cleaning assembly 1. When the saliva suction assembly 3 is connected to the cleaning assembly 1, the first conveying assembly 5 is configured to convey the cleaning liquid supplied by the cleaning assembly 1 to the spittoon 2 and the saliva suction assembly 3 respectively. The second conveying assembly 6 is connected to the sewage container 4. When the saliva suction assembly 3 contacts oral sewage, the second conveying assembly 6 is configured to convey the oral sewage at the saliva suction assembly 3 to the sewage container 4. When the saliva suction assembly 3 is connected to the cleaning assembly 1, the second conveying assembly 6 is configured to convey a mixed liquid conveyed to the spittoon 2 and the saliva suction assembly 3 to the sewage container 4.

In this embodiment, the workbench control assembly is integrated into a dental nurse workbench. The cleaning assembly 1 may include a liquid supply end arranged outside the workbench (such as an external faucet or a pipe for conveying the cleaning liquid) and/or a container storing the cleaning liquid within the workbench. The cleaning liquid may include clean water, disinfectant, detergent, or other liquids with cleaning properties, as well as mixtures thereof. The saliva suction assembly 3 may include a tip and a device for generating negative pressure at the tip. When the tip is inserted into the patient's mouth and contacts with oral sewage, the oral sewage may be sucked by activating a negative pressure device. The cleaning assembly 1, the spittoon 2, the saliva suction assembly 3, and the sewage container 4 may be interconnected with each other through corresponding pipelines. The first conveying assembly 5 and the second conveying assembly 6 may include devices, such as pumps and valves, arranged within the corresponding pipelines to control the flow of liquids, so that the cleaning liquid, the oral sewage, the mouth rinse wastewater and the mixed liquid may be conveyed to the corresponding devices by the first conveying assembly 5 and the second conveying assembly 6 along the corresponding pipelines.

Based on the above arrangement, in practical application, the patient may spit the mouth rinse wastewater into the spittoon 2, and this portion of the mouth rinse wastewater may be collected into the sewage container 4 under the action of the second conveying assembly 6. The saliva suction assembly 3 may suck the patient's oral sewage, and this portion of oral sewage may be collected into the sewage container 4 under the action of the second conveying assembly 6. The cleaning liquid supplied by the cleaning assembly 1 may be conveyed to the spittoon 2 by the first conveying assembly 5 to clean the spittoon 2, thereby ensuring the cleanliness of the exposed spittoon 2, and preventing harmful substances in the mouth rinse wastewater from adhering to an inner wall of the spittoon 2, which may lead to bacterial growth and other issues. After cleaning, the cleaning water and the mouth rinse wastewater in the spittoon 2 form a mixed liquid, and the mixed liquid will be collected into the sewage container 4 under the action of the second conveying assembly 6.

After each device has been used for a period of time, a considerable amount of contaminants will accumulate in each device and the corresponding pipes. At this time, a centralized cleaning of all devices is required. The healthcare workers may direct the sewage discharge end of the sewage container 4 to an external discharge area and activate the discharge end to empty the mixed liquid stored in the sewage container 4, which includes mouth rinse wastewater, oral sewage, and cleaning water. Then the saliva suction assembly 3 is connected to the cleaning assembly 1 through an adapter 13. At this time, the cleaning liquid supplied by the cleaning assembly 1 may be respectively conveyed to the spittoon 2 and the saliva suction assembly 3 under the action of the first conveying assembly 5. Then, under the action of the second conveying assembly 6, these liquids are collected into the sewage container 4 and ultimately discharged outward through the sewage discharge end of the sewage container 4. During the flow of the cleaning liquid, the spittoon 2, the saliva suction assembly 3, the sewage container 4 and the corresponding pipelines may be uniformly cleaned, ultimately completing the sewage discharge operation.

It can be seen that based on the workbench control assembly provided in this embodiment, through the rational arrangement of the cleaning assembly 1, the spittoon 2, the saliva suction assembly 3 and the sewage container 4, may orderly accomplish a series of tasks such as unified collection of sewage, cleaning of devices, and centralized sewage discharge through the liquid transfer operations between various devices by using the first conveying assembly 5 and the second conveying assembly 6. Moreover, the operations do not interfere with each other, thereby improving the sewage discharge efficiency and reducing the risk of direct contact between healthcare workers and harmful substances in the sewage.

In an embodiment, referring to FIG. 1 and FIG. 3, the cleaning assembly 1 includes a cleaning container 101 and an external liquid supply pipeline 102. The cleaning container 101 is in communication with the external liquid supply pipeline 102, the cleaning container 101 is connected to the spittoon 2, and the saliva suction assembly 3 is in communication with the external liquid supply pipeline 102. The cleaning container 101 is configured to store the cleaning liquid.

Specifically, by setting the cleaning container 101, it is possible to utilize the cleaning liquid stored in the cleaning container 101 for the daily cleaning of the spittoon 2, even in situations where it is inconvenient to connect to an external liquid supply. This maintains the cleanliness of the exposed spittoon 2, prevent harmful substances from the mouth rinse wastewater from adhering to the inner walls of the spittoon 2, thereby avoiding issues such as bacterial proliferation, and enhancing the convenience of cleaning. The external liquid supply pipeline 102 is utilized during phases when centralized cleaning and sewage discharge of various devices are required. The external liquid supply pipeline 102 may include a plurality of pipes and corresponding pipe end joints, at least part of the pipes are connected to the external liquid supply end, for example, it may be connected to the external tap water supply 1023, so as to uniformly clean the cleaning container 101, the spittoon 2, the saliva suction assembly 3, the sewage container 4 and corresponding pipelines through the external liquid supply end, or to replenish the cleaning liquid into the cleaning container 101 through the external liquid supply end.

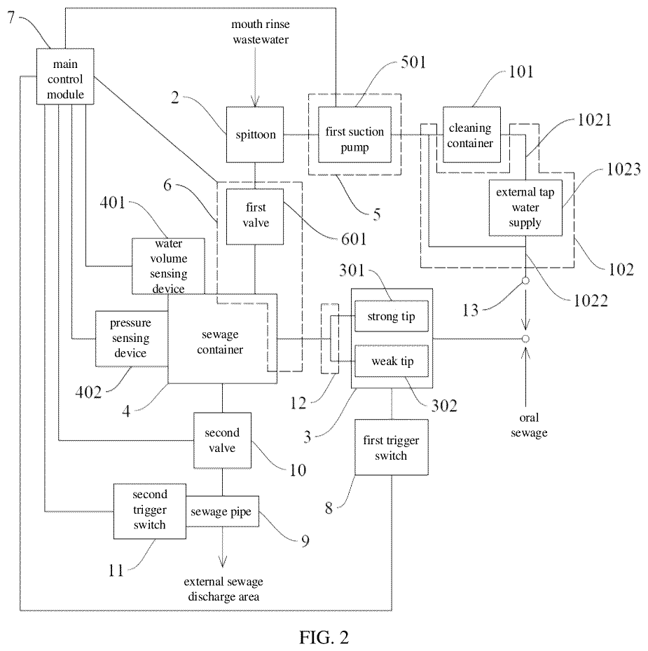

In an embodiment, referring to FIG. 2 and FIG. 3, the external liquid supply pipeline 102 includes a first pipe 1021 and a second pipe 1022. A first end of the first pipe 1021 is connected to an external tap water supply 1023, a second end of the first pipe 1021 is in communication with the cleaning container 101. A first end of the second pipe 1022 is connected to the external tap water supply 1023 and/or the cleaning container 101, and a second end of the second pipe 1022 is connected to the saliva suction assembly 3.

Specifically, based on the pipeline arrangement of the present embodiment, the saliva suction assembly 3, in addition to being cleaned during the centralized unified cleaning phase using the external tap water supply 1023, may also, during routine utilize, be cleaned in a manner similar to the cleaning of the spittoon 2. The saliva suction assembly 3 may be connected to the second end of the second pipe 1022 through an adapter 13, allowing the cleaning liquid stored in the cleaning container 101 to be utilized for the daily cleaning of the saliva suction assembly 3, thereby ensuring the daily cleanliness of the saliva suction assembly 3. The wastewater after cleaning will be collected into the sewage container 4 under the action of the second conveying assembly 6. After cleaning, the suction assembly 3 may be detached from the second end of the second pipe 1022 and continue to perform the operation of suctioning oral sewage.

Additionally, based on the arrangement of the second pipe 1022, during the process of unified centralized cleaning of the devices, if the first end of the second pipe 1022 is connected to the external tap water supply 1023, the external tap water supply 1023 may directly supply tap water to the saliva suction assembly 3 to clean the suction assembly 3. And if the first end of the second pipe 1022 is connected to the cleaning container 101, the tap water supplied by the external tap water supply 1023 will, after passing through the cleaning container 101, carry the residual disinfectant, detergent, or other cleaning liquids from the cleaning container 101 to the saliva suction assembly 3, thereby cleaning the saliva suction component 3. Compared with the method of cleaning the saliva suction assembly 3 only with tap water, the cleaning effect may be improved, thereby improving the cleanliness of the saliva suction assembly 3 after cleaning.

It is understandable that, in practical applications, the first end of the second pipe 1022 may be connected to one of the external tap water supply 1023 and the cleaning container 101, or may be connected to both the external tap water supply 1023 and the cleaning container 101 at the same time, which is not limited here.

In an embodiment, referring to FIG. 1 and FIG. 3, the saliva suction assembly 3 includes a strong tip 301 and a weak tip 302, and the workbench waterway integrated system further includes a tee fitting 12. A first connection end of the tee fitting 12 is in communication with the strong tip 301, a second connection end of the tee fitting 12 is in communication with the weak tip 302, and a third connection end of the tee fitting 12 is in communication with the sewage container 4.

Specifically, the strong tip 301 and the weak tip 302 correspond to different negative pressure powers, making them suitable for scenarios with varying requirements for the suction force of mouth rinse sewage. By setting the tee fitting 12, both the strong tip 301 and the weak tip 302 may be simultaneously connected to the sewage container 4, thereby enabling the simultaneous collection of sewage and cleaning of sewage from both the strong tip 301 and the weak tip 302.

In an embodiment, referring to FIG. 1 and FIG. 3, the cleaning container 101 is connected to the spittoon 2 through a first suction pump 501, and a first valve 601 is arranged at a connecting channel between the spittoon 2 and the sewage container 4.

The workbench control assembly further includes a main control module 7, the main control module 7 is electrically connected to the first suction pump 501 and the first valve 601. The main control module 7 is configured to simultaneously send a first opening signal to the first suction pump 501 and the first valve 601 when receiving an external sewage discharge instruction. The first suction pump 501 is configured to perform a suction operation to suck the cleaning liquid in the cleaning container 101 into the spittoon 2 when receiving the first opening signal. The first valve 601 is configured to open when receiving the first opening signal.

Specifically, since the spittoon 2 typically handles a small amount of mouth rinse wastewater, the first valve 601 may remain in a normally closed state. However, when cleaning the spittoon 2 is required, as the volume of cleaning water is larger, the first valve 601 needs to be opened to allow the water in the spittoon 2 to flow into the sewage container 4 in time, preventing overflow of the water in the spittoon 2. Based on this consideration, the present embodiment further includes a main control module 7. The main control module 7 may include an MCU (Microcontroller Unit), a microcontroller, or other modules capable of basic functions such as signal input/output, data storage, logic judgment, and numerical calculation. When the spittoon 2 needs to be cleaned, the healthcare workers may input an external sewage discharge instruction into the main control module 7, which triggers the synchronized operation of the first suction pump 501 and the first valve 601, thereby causing the first suction pump 501 to start sucking the cleaning liquid from the cleaning container 101 to the spittoon 2 for cleaning, and simultaneously opening the first valve 601 to discharge the water from the spittoon 2 into the sewage container 4. Through this coordinated operation, both the cleaning and sewage collection processes may be ensured to proceed smoothly.

The triggering terminal on the main control module 7 for receiving the external sewage discharge instruction may be set as a touch button on a liquid crystal control panel. The healthcare workers may input the external sewage discharge instruction by either tapping or long-pressing the touch button.

In an embodiment, referring to FIG. 1 and FIG. 3, the saliva suction assembly 3 is provided with a first trigger switch 8. The workbench control assembly further includes a main control module 7, the main control module 7 is electrically connected to the first trigger switch 8 and the second conveying assembly 6.

When the first trigger switch 8 changes from a state of not being affected by an external action to a state of being affected by the external action, the first trigger switch 8 is configured to send a first trigger signal to the main control module. When the first trigger switch 8 changes from a state of being affected by an external action to a state of not being affected by the external action, the first trigger switch 8 is configured to send a second trigger signal to the main control module 7.

The main control module 7 is configured to send a first stop signal to the second conveying assembly 6 when receiving the first trigger signal, and the main control module 7 is configured to send a first start signal to the second conveying assembly 6 when receiving the second trigger signal.

The second conveying assembly 6 is configured to stop conveying the oral sewage at the saliva suction assembly 3 to the sewage container 4 when receiving the first stop signal, and the second conveying assembly 6 is configured to start conveying the oral sewage at the saliva suction assembly 3 to the sewage container 4 when receiving the first start signal.

In practical applications, the saliva suction assembly 3 is typically required to be hung on a hanger of a dental nurse's workbench after utilizing. Based on this usage scenario, by arranging the first trigger switch 8 at the saliva suction assembly 3, the interaction between the first trigger switch 8 and the hanger may automatically trigger the saliva suction assembly 3 to start or stop suction, thereby improving the automation and intelligence of the devices. Specifically, the first trigger switch 8 may be a sensor device that may be triggered by an external action, such as a contact switch, a pressure sensor, or a photoelectric switch. The external action may refer to a force applied to the first trigger switch 8, a distance between the first trigger switch 8 and the target device reaching a preset distance threshold, or a light emitted by the first trigger switch 8 being obstructed by the target device, etc. Taking the first trigger switch 8 implemented as a pressure-sensitive sensor as an example, a press may be arranged at the position where the saliva suction assembly 3 contacts the hanger. When the saliva suction assembly 3 is utilized and hung on the hanger, the press is compressed and rotated by a certain angle. At this point, the press transitions from a state of not being affected by an external action to a state of being affected by the external action and sends the first trigger signal to the main control module 7, thereby triggering the main control module 7 to control the second conveying assembly 6 to stop conveying oral sewage from the saliva suction assembly 3 to the sewage container 4, that is, stop the oral sewage suction operation. When the saliva suction assembly 3 is needed, the saliva suction assembly 3 is removed from the hanger, so that an elastic press is no longer compressed and returns to its original angle. At this point, the press transitions from a state of being affected by an external action to a state of not being affected by the external action and sends a second trigger signal to the main control module 7, thereby triggering the main control module 7 to control the second conveying assembly 6 to start convey the oral sewage from the saliva suction assembly 3 to the sewage container 4, that is, start the oral sewage suction operation.

In an embodiment, referring to FIG. 1 and FIG. 3, the sewage container 4 is provided with a water volume sensing device 401, and the water volume sensing device 401 is electrically connected to the main control module 7.

The main control module 7 is configured to send a water volume detection signal to the water volume sensing device 401 when receiving the second trigger signal. The water volume sensing device 401 is configured to start obtaining a real-time sewage volume in the sewage container 4 when receiving the water volume detection signal, and the water volume sensing device 4 is configured to send a water volume indication signal to the main control module 7 when the real-time sewage volume reaches a preset water volume threshold. The main control module 7 is configured to perform an alarm operation or send a second stop signal to the second conveying assembly 6 when receiving the water volume indication signal. The second conveying assembly 6 is configured to stop delivering the oral sewage at the saliva suction assembly 3 to the sewage container 4 when receiving the second stop signal.

By setting the water volume sensing device 401, an alarm operation may be executed in time or the second conveying assembly 6 may be triggered to stop the oral sewage suction operation when the amount of sewage stored in the sewage container 4 exceeds a certain limit, so as to inform the healthcare workers to intervene in time and prevent the external mixed liquid from continuing to flow into the sewage container 4 and overflow from the sewage container 4. The preset water volume threshold of the water volume sensing device 401 may be set to multiple gears. When the real-time sewage volume in the sewage container 4 reaches a lowest gear, an alarm operation is executed. When the real-time sewage volume in the sewage container 4 reaches a highest gear, the second conveying assembly 6 is directly controlled to stop the oral sewage suction operation.

In addition, when the main control module 7 receives the second trigger signal, it indicates that the saliva suction assembly 3 is removed from the hanger of the dental nurse workbench by the healthcare workers, which means that the oral sewage suction operation is required at this time. At this time, the main control module 7 sends the water volume detection signal to the water volume sensing device 401, so that the water volume sensing device 401 starts to operate when the oral sewage suction operation is required. In this way, it may avoid the water volume sensing device 401 from being continuously turned on when it is not needed, thereby avoiding unnecessary energy consumption.

In an embodiment, the main control module 7 may also be electrically connected to a display device such as a liquid crystal control panel, so that the real-time sewage volume obtained by the water volume sensing device 401 may be presented in real time through the display device, thereby making it more conducive for healthcare workers to accurately control the timing of sewage discharge.

In an embodiment, referring to FIG. 1 and FIG. 3, the sewage container 4 is provided with a pressure sensing device 402, and the pressure sensing device 402 is electrically connected to the main control module 7.

The main control module 7 is configured to send a pressure detection signal to the pressure sensing device 402 when receiving the second trigger signal. The pressure sensing device 402 is configured to start obtaining a negative pressure value in the sewage container 4 when receiving the pressure detection signal, and the pressure sensing device 402 is configured to send a pressure indication signal to the main control module 7 when the negative pressure value reaches a preset pressure threshold. The main control module 7 is configured to perform an alarm operation or send a third stop signal to the second conveying assembly 6 when receiving the pressure indication signal. The second conveying assembly 6 is configured to stop conveying the oral sewage at the saliva suction assembly 3 to the sewage container 4 when receiving the third stop signal.

By setting the pressure sensing device 402, an alarm operation may be executed in time or the second conveying assembly 6 may be triggered to stop the oral sewage suction operation when an abnormal pressure condition occurs within the sewage container 4, so as to inform the healthcare workers to intervene in time to avoid the pressure being too low to cause normal suction and the pressure being too high to cause discomfort to the patient. The preset pressure threshold of the pressure sensing device 402 may be set to multiple gears. When the negative pressure value in the sewage container 4 reaches the lowest gear, an alarm operation is executed. When the negative pressure value in the sewage container 4 reaches the highest gear, the second conveying assembly 6 is directly controlled to stop the oral sewage suction operation.

In addition, when the main control module 7 receives the second trigger signal, it indicates that the saliva suction assembly 3 is removed from the hanger of the dental nurse workbench by the healthcare workers, which means that the oral sewage suction operation is required at this time. At this time, the main control module 7 sends the water volume detection signal to the water volume sensing device 401, so that the water volume sensing device 401 starts to operate when the oral sewage suction operation is required. In this way, it may avoid the water volume sensing device 401 from being continuously turned on when it is not needed, thereby avoiding unnecessary energy consumption.

In an embodiment, the main control module 7 may also be electrically connected to a display device such as a liquid crystal control panel, so that the real-time sewage volume obtained by the water volume sensing device 401 may be presented in real time through the display device, thereby making it more conducive for healthcare workers to accurately control the real-time status of the saliva suction operation.

In an embodiment, referring to FIG. 1 and FIG. 3, a sewage discharge end of the sewage container 4 is connected to a sewage discharge pipe 9, a second valve 10 is arranged in the sewage discharge pipe 9, and a second trigger switch 11 is arranged at the sewage discharge pipe 9. The main control module 7 is electrically connected to the second valve 10 and the second trigger switch 11.

When the second trigger switch 11 changes from a state of not being affected by an external action to a state of being affected by the external action, the second trigger switch 11 is configured to send a third trigger signal to the main control module 7. When the second trigger switch 11 changes from a state of being affected by an external action to a state of not being affected by the external action, the second trigger switch 11 is configured to send a fourth trigger signal to the main control module 7.

The main control module 7 is configured to send a first closing signal to the second valve 10 when receiving the third trigger signal, and the main control module 7 is configured to send a second opening signal to the second valve 10 when receiving the fourth trigger signal.

The second valve 10 is configured to close when receiving the first closing signal, and the second valve 10 is configured to open when receiving the second opening signal.

In practical applications, the sewage discharge pipe 9 typically needs to be hung on the hanger of the dental nurse's workbench after sewage discharge is completed. Based on this usage scenario, by arranging the second trigger switch 11 at the sewage discharge pipe 9, the interaction between the second trigger switch 11 and the hanger may automatically trigger the opening or closing of the second valve 10. This allows the sewage disposal to automatically start after the sewage discharge pipe 9 is removed from the hanger, and automatically stop after the sewage discharge pipe 9 is hung back on the hanger, thereby improving the automation and intelligence of the device.

Specifically, the second trigger switch 11 may be sensing devices that may be triggered by external forces, such as a contact switch, a pressure-sensitive sensor, or a photoelectric switch. The external force may refer to the second trigger switch 11 being subjected to a certain external force, the distance between the second trigger switch 11 and the target device reaching a preset threshold, or the light emitted by the second trigger switch 11 being blocked by the target device, etc. Taking the first trigger switch 8 implemented as a pressure-sensitive sensor as an example, the press may be arranged at the contact point between the sewage discharge pipe 9 and the hanger. When the sewage discharge is completed and the sewage discharge pipe 9 is hung on the hanger, the press is compressed and rotated by a certain angle. At this point, the press transitions from a state of not being affected by an external action to a state of being affected by the external action, sending the third trigger signal to the main control module 7, which then controls the second valve 10 to close and stop the sewage discharge. When the sewage discharge is needed, the sewage discharge pipe 9 is removed from the hanger, so that the elastic press is no longer compressed and returns to its original angle. In this case, the press transitions from a state of being affected by an external action to a state of not being affected by the external action, sending the fourth trigger signal to the main control module 7, thereby triggering the main control module 7 to control the opening of the second valve 10 and start the sewage discharge.

In an embodiment, referring to FIG. 1 and FIG. 3, the main control module 7 is configured to send a second closing signal to the second valve 10 when receiving the second trigger signal, and the second valve 10 is configured to close when receiving the second closing signal.

Specifically, when the main control module 7 receives the second trigger signal, it indicates that the saliva suction assembly 3 is removed from the hanger of the dental nurse workbench by the healthcare workers, which means that the oral sewage suction operation is required at this time. At this time, the main control module 7 sends the second closing signal to the second valve 10, which may ensure that the second valve 10 is in a closed state during the saliva suction stage, preventing the second valve 10 from opening autonomously during the saliva suction stage due to a signal error, which could lead to the outflow of sewage and cause adverse effects.

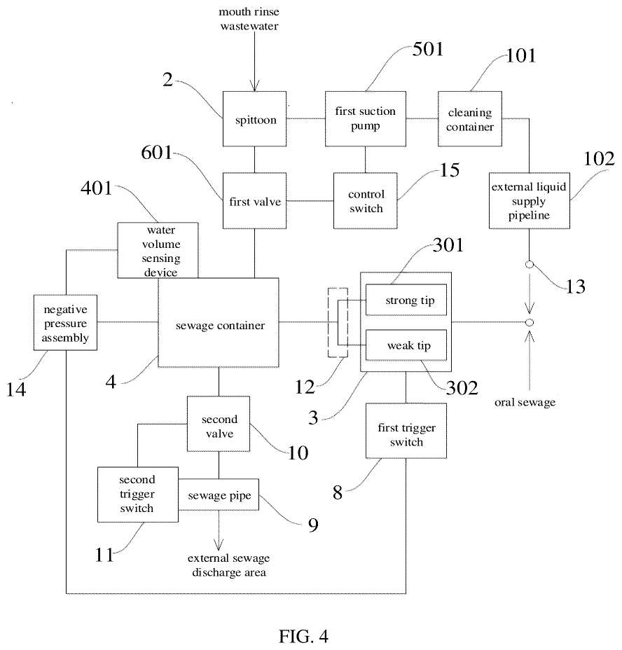

Referring to FIG. 3 and FIG. 4, the present application further provides a workbench waterway integrated system, the workbench waterway integrated system includes a sewage container 4, a spittoon 2, a cleaning container 101, a saliva suction assembly 3, a sewage discharge end of the sewage container 4 is in communication with an external sewage discharge area. The spittoon 2 is configured to receive mouth rinse wastewater, and a liquid discharge port of the spittoon 2 is connected to a first liquid collection end of the sewage container. A replenishment end of the cleaning container 101 is in communication with an external liquid supply pipeline 102, and a liquid supply end of the cleaning container 101 is in communication with a liquid inlet of the spittoon 2. The cleaning container 101 is configured to supply a cleaning liquid to the spittoon 2 to clean the spittoon 2. A discharge end of the saliva suction assembly 3 is in communication with a second liquid collection end of the sewage container 4, and a liquid inlet end of the saliva suction assembly 3 is configured to suck oral sewage or to be in communication with the external liquid supply pipeline 102.

In this embodiment, it can be understood that the sewage container 4, the spittoon 2, the cleaning container 101, and the saliva suction assembly 3 may be interconnected through corresponding pipes, and pumps, valves and other devices for controlling the flow of liquid may be correspondingly arranged at the pipes to ensure that the preset amount of liquid may be guided to the corresponding position along a preset path.

The cleaning liquid stored in the cleaning container 101 may include clean water, disinfectant, detergent and other liquids with washing and cleaning effects and mixtures thereof. The saliva suction assembly 3 may include a tip, a pipe and a device for generating negative pressure at the tip. When the tip is inserted into the patient's oral cavity and contacts the oral sewage, the oral sewage may be sucked into the sewage container 4 by activating a negative pressure device. The external liquid supply pipeline 102 may include a plurality of pipes and corresponding pipe end joints, at least part of the pipes are connected to an external liquid supply end, for example, it may be connected to an external tap water supply 1023, so as to replenish the cleaning liquid to the cleaning container 101 through the external liquid supply end and to clean each device.

Based on the above waterway layout, in practical application, the patient may spit the mouth rinse wastewater into the spittoon 2, and this portion of the mouth rinse wastewater will pass through the discharge end of the spittoon 2 and the first liquid collection end of the sewage container 4 in sequence and be collected in an inner cavity of the sewage container 4. The saliva suction assembly 3 may suck the patient's oral sewage, and the portion of the oral sewage will pass through the liquid inlet end of the saliva suction assembly 3, the liquid discharge end of the saliva suction assembly 3, and the second liquid collection end of the sewage container 4 in sequence and be collected in the inner cavity of the sewage container 4. The cleaning liquid stored in the cleaning container 101 may be supplied to the spittoon 2 through a liquid supply end of the cleaning container 101 and the liquid inlet of the spittoon 2, thereby performing daily cleaning of the spittoon 2, ensuring the cleanliness of the exposed spittoon 2, and preventing harmful substances in the mouth rinse wastewater from adhering to the inner wall of the spittoon 2, which may lead to bacterial growth and other issues. The cleaning water after cleaning will pass through the liquid discharge end of the spittoon 2 and the first liquid collection end of the sewage container 4 in sequence and be collected into the inner cavity of the sewage container 4. When the cleaning liquid stored in the cleaning container 101 is insufficient, the healthcare workers may add the external cleaning liquid to the cleaning container 101 along the external liquid supply pipeline 102 and a liquid replenishing end of the cleaning container 101.

After each device has been used for a period of time, a considerable amount of contaminants will accumulate in each device and the corresponding pipes. At this time, a centralized cleaning of all devices is required. The healthcare workers may direct the sewage discharge end of the sewage container 4 to an external sewage discharge area and activate the sewage discharge end to empty the mixed liquid stored in the sewage container 4, which includes mouth rinse wastewater, oral sewage, and cleaning water. Then, the liquid inlet end of the saliva suction assembly 3 is connected to the external liquid supply pipeline 102 and the external liquid supply end is opened. At this time, the external cleaning liquid will be supplied along two paths through the external liquid supply pipeline 102, one path of the cleaning liquid sequentially passes through the liquid replenishing end of the cleaning container 101, the liquid supply end of the cleaning container 101, the liquid inlet of the spittoon 2, the liquid discharge end of the spittoon 2, and the first liquid collection end of the sewage container 4, and is finally discharged from the sewage discharge end of the sewage container 4 to the external sewage discharge area. During the flow of this path of the cleaning liquid, the cleaning container 101, the spittoon 2, the sewage container 4 and the connection pipes thereof will be cleaned. The other path of the cleaning liquid sequentially passes through the liquid inlet end of the saliva suction assembly 3, the discharge end of the saliva suction assembly 3, the second liquid collection end of the sewage container 4, and is finally discharged from the sewage discharge end of the sewage container 4 to the external sewage discharge area. During the flow of this path of the cleaning liquid, the cleaning of the saliva suction assembly 3, the sewage container 4 and the connection pipes thereof will be cleaned.

It can be seen that based on the workbench waterway integrated system provided in this embodiment, through the rational arrangement of the connection pipes between the sewage container 4, the spittoon 2, the cleaning container 101, and the saliva suction assembly 3, may orderly accomplish a series of tasks such as unified collection of sewage, cleaning of devices, and centralized sewage discharge. Moreover, the operations do not interfere with each other, thereby improving the sewage discharge efficiency and reducing the risk of direct contact healthcare workers and harmful substances in the sewage.

In this embodiment, referring to FIG. 3 and FIG. 4, a plurality of the liquid inlets are arranged at the spittoon 2, the plurality of the liquid inlets are arranged circumferentially around a upper side of the spittoon 2, and a liquid discharge port is arranged at the bottom of the spittoon 2. Based on this arrangement, the cleaning liquid supplied from the cleaning container 101 to the spittoon 2 will flow from multiple angles along the inner wall of the spittoon 2 to the liquid discharge at the bottom of the spittoon 2, that is, the flow area of the cleaning liquid may more comprehensively cover the inner wall of the spittoon 2, thereby enabling a more thorough and complete cleaning of the spittoon 2, reducing the probability that certain contaminants will continue to adhere to the inner wall of the spittoon 2 due to inadequate cleaning liquid flushing. Similarly, in the process of uniformly and centrally cleaning various devices, the external cleaning liquid may also be configured to completely clean the spittoon 2 through multiple circumferentially arranged liquid inlets, thereby improving the cleanliness of the spittoon 2.

In an embodiment, referring to FIG. 3 and FIG. 4, the saliva suction assembly 3 includes a strong tip 301 and a weak tip 302, and the workbench waterway integrated system further includes a tee fitting 12. A first connection end of the tee fitting 12 is in communication with the strong tip 301, a second connection end of the tee fitting 12 is in communication with the weak tip 302, and a third connection end of the tee fitting 12 is in communication with the second liquid collection end of the sewage container 4.

Specifically, the strong tip 301 and the weak tip 302 correspond to different negative pressure powers, making them suitable for scenarios with varying requirements for the suction force of mouth rinse sewage. By setting the tee fitting 12, both the strong tip 301 and the weak tip 302 may be simultaneously connected to the sewage container 4, thereby enabling the synchronous collection and cleaning of sewage from both the strong tip 301 and the weak tip 302.

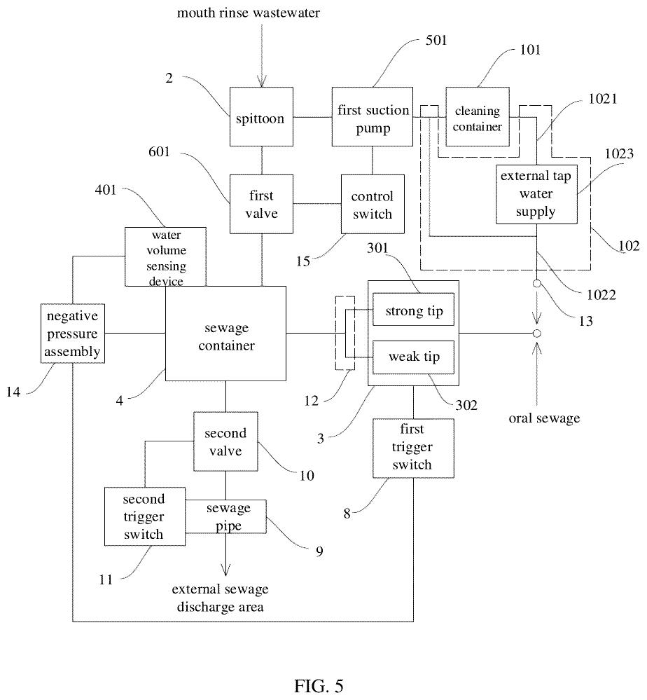

In an embodiment, referring to FIG. 3 and FIG. 5, the external liquid supply pipeline 102 includes a first pipe 1021 and a second pipe 1022. A first end of the first pipe 1021 is connected to an external tap water supply 1023, a second end of the first pipe 1021 is in communication with the replenishment end of the cleaning container 101. A first end of the second pipe 1022 is connected to the external tap water supply 1023 and/or the liquid supply end of the cleaning container 101, and a second end of the second pipe 1022 is in communication with the saliva suction assembly 3.

Specifically, based on the pipeline arrangement of the present embodiment, the saliva suction assembly 3, in addition to being cleaned during the centralized unified cleaning phase using the external tap water supply 1023, may also, during routine utilize, be cleaned in a manner similar to the cleaning of the spittoon 2. The liquid inlet end of the saliva suction assembly 3 is connected to the second end of the second pipe 1022, and the cleaning liquid stored in the cleaning container 101 may be supplied to the saliva suction assembly 3 through the liquid supply end of the cleaning container 101, the first end of the second pipe 1022, and the second end of the second pipe 1022 in sequence, in order to perform routine cleaning on the saliva suction assembly 3 and ensure the daily cleanliness of the saliva suction assembly 3. The cleaning water after cleaning will sequentially pass through the liquid discharge end of the saliva suction assembly 3 and the second liquid collection end of the sewage container 4 and be collected in the inner cavity of the sewage container 4. After cleaning, the liquid inlet end of the saliva suction assembly 3 may be detached from the second end of the second pipe 1022 and continue to suck the oral sewage.

Additionally, based on the arrangement of the second pipe 1022, during the process of unified centralized cleaning of the devices, if the first end of the second pipe 1022 is connected to the external tap water supply 1023, the external tap water supply 1023 may directly supply tap water to the saliva suction assembly 3 to clean the suction assembly 3. And if the first end of the second pipe 1022 is connected to the liquid supply end of the cleaning container 101, the tap water supplied by the external tap water supply 1023 will, after passing through the cleaning container 101, carry the residual disinfectant, detergent, or other cleaning liquids from the cleaning container 101 to the saliva suction assembly 3, thereby cleaning the saliva suction component 3. Compared with the method of cleaning the saliva suction assembly 3 only with tap water, the cleaning effect may be improved, thereby improving the cleanliness of the saliva suction assembly 3 after cleaning.

It is understandable that, in practical applications, the first end of the second pipe 1022 may be connected to one of the external tap water supply 1023 and the cleaning container 101, or may be connected to both the external tap water supply 1023 and the cleaning container 101 at the same time, which is not limited here.

In an embodiment, referring to FIG. 3 and FIG. 4, the workbench waterway integrated system further includes a negative pressure assembly 14, the negative pressure assembly 14 is in communication with a negative pressure end of the sewage container 4. The negative pressure assembly 14 is configured to generate a negative pressure inside the sewage container, so as to uniformly suck external mixed liquid into an inner cavity of the sewage container through the first liquid collection end and the second liquid collection end. The negative pressure assembly 14 may include a negative pressure pump and associated electronic control devices. The external mixed liquid refers to the mouth rinse wastewater, the oral sewage and the cleaning liquid discharged from the spittoon 2 and the saliva suction assembly 3 into the sewage container 4.

In an embodiment, referring to FIG. 3 and FIG. 4, the saliva suction assembly 3 is provided with a first trigger switch 8, and the first trigger switch 8 is electrically connected to the negative pressure assembly 14.

When the first trigger switch 8 changes from a state of not being affected by an external action to a state of being affected by the external action, the first trigger switch 8 is configured to send a first closing signal to the negative pressure assembly 14. When the first trigger switch 8 changes from a state of being affected by an external action to a state of not being affected by the external action, the first trigger switch 8 is configured to send a first opening signal to the negative pressure assembly 14.

The negative pressure assembly 14 is configured to exit a negative pressure working state when receiving the first closing signal, and the negative pressure assembly 14 is configured to enter the negative pressure working state when receiving a first opening signal.

In practical applications, the saliva suction assembly 3 is typically required to be hung on the hanger of a dental nurse's workbench after utilizing. Based on this usage scenario, by arranging a first trigger switch 8 at the saliva suction assembly 3, the interaction between the first trigger switch 8 and the hanger may automatically trigger the saliva suction assembly 3 to start or stop suction, thereby improving the automation and intelligence of the devices. Specifically, the first trigger switch 8 may be implemented using a contact switch, a pressure-sensitive sensor, a photoelectric switch, or other sensor devices that may be triggered by external actions. The external action may refer to the application of an external force on the first trigger switch 8, the distance between the first trigger switch 8 and the target device reaching a preset threshold, or the light emitted by the first trigger switch 8 being blocked by the target device, etc. Taking the first trigger switch 8 implemented as a pressure-sensitive sensor as an example, a press may be arranged at the position where the saliva suction assembly 3 contacts the hanger. When the saliva suction assembly 3 is utilized and hung on the hanger, the press is compressed and rotated by a certain angle. At this point, the press transitions from a state of not being affected by an external action to a state of being affected by the external action and sends a first trigger signal to the negative pressure assembly 14 to exit the negative pressure working state. When the saliva suction assembly 3 is needed, the saliva suction assembly 3 is removed from the hanger, so that the elastic press is no longer compressed and returns to its original angle. At this point, the press transitions from a state of being affected by an external action to a state of not being affected by the external action, and sends the first start signal to the negative pressure assembly 14 to enter the negative pressure working state.

It can be understood that the negative pressure assembly 14 enters the negative pressure working state, which may refer to the negative pressure assembly 14 immediately starting to perform the negative pressure suction operation, or it may refer to the negative pressure assembly 14 being in a state where it may immediately start to perform the negative pressure suction operation. If the negative pressure assembly 14 is in a state where it may immediately start to perform the negative pressure suction operation, the negative pressure assembly 14 also needs to receive another trigger signal before it may start to perform the negative pressure suction operation, and the trigger signal may be issued by healthcare workers through switches, knobs, buttons, touch screens and other devices according to the actual operation timing. Similarly, the negative pressure assembly 14 exits the negative pressure working state, it may refer to the negative pressure assembly 14 immediately stopping to perform the negative pressure suction operation, or it may refer to the state in which the negative pressure assembly 14 may immediately stop the negative pressure suction operation. If the negative pressure assembly 14 is in a state where it may immediately stop to perform the negative pressure suction operation, the negative pressure assembly 14 also needs to receive another trigger signal before it may stop to perform the negative pressure suction operation, and the trigger signal may be issued by healthcare workers through switches, knobs, buttons, touch screens and other devices according to the actual operation timing.

In an embodiment, referring to FIG. 3 and FIG. 4, the sewage container 4 is provided with a water volume sensing device 401, and the water volume sensing device 401 is electrically connected to the negative pressure assembly.

The water volume sensing device 401 is configured to obtain a real-time sewage volume in the sewage container, and the water volume sensing device 401 is configured to send a stop signal to the negative pressure assembly 14 when the real-time sewage volume reaches a preset water volume threshold. The negative pressure assembly 14 is configured to stop the negative pressure operation when receiving the stop signal.

By setting the water volume sensing device 401, the negative pressure assembly 14 may be triggered to stop the negative pressure suction operation in time when the stored sewage exceeds a certain level, preventing the external mixed liquid from continuing to enter the sewage container 4 and overflowing from the sewage container 4, thereby avoiding environmental pollution. The water volume sensing device 401 may also be electrically connected to a display device such as a liquid crystal control panel to provide real-time indication of the wastewater level in the wastewater container 4, thereby enabling healthcare workers to more accurately control the timing of sewage discharge.

In an embodiment, referring to FIG. 3 and FIG. 4, the liquid supply end of the cleaning container 101 is connected to the liquid inlet of the spittoon 2 through a first suction pump 501, and a first valve 601 is arranged at a connection pipe between the liquid discharge port of the spittoon 2 and the first liquid collection end of the sewage container 4.

The workbench waterway integrated system further includes a control switch 15, the control switch 15 is electrically connected to the first suction pump 501 and the first valve 601. The control switch 15 is configured to simultaneously send a second opening signal to the first suction pump 501 and the first valve 601 when receiving an external sewage discharge instruction. The first suction pump 501 is configured to perform a suction operation to suck the cleaning liquid in the cleaning container 101 into the spittoon 2 when receiving the second opening signal. The first valve 601 is configured to open when receiving the second opening signal.

Specifically, since the spittoon 2 typically handles a small amount of mouthwash wastewater, the first valve 601 may remain in a normally closed state. However, when the spittoon 2 needs to be cleaned, due to the volume of cleaning water is larger, the first valve 601 needs to be opened to allow the water in the spittoon 2 to flow into the sewage container 4 in time, preventing overflow of the water in the spittoon 2. Based on this consideration, the present embodiment provides a control switch 15. When the spittoon 2 needs to be cleaned, the healthcare workers may input an external sewage discharge instruction to the control switch 15 to trigger the first suction pump 501 and the first valve 601 to operate synchronously, so that the first suction pump 501 starts to suck the cleaning liquid in the cleaning container 101 to the spittoon 2 to clean the spittoon 2. The first valve 601 is also opened at the same time to discharge the cleaning water at the spittoon 2 into the sewage container 4 in time. Based on the above synergistic effect, the normal cleaning operation and sewage collection operation may be ensured.

The control switch 15 may be set as a touch button on the liquid crystal control panel, and the healthcare workers may input the external sewage discharge instruction by clicking or long pressing the touch button.

In an embodiment, referring to FIG. 3 and FIG. 4, the workbench waterway integrated system includes an adapter 13, the adapter 13 is configured to lock on a fixed housing, and a first end of the adapter 13 forms a quick-connect interface. A liquid inlet end of the saliva suction assembly 3 is configured to be plugged into a first end of the adapter 13, and a second end of the adapter 13 is in communication with the external liquid supply pipeline 102.

The fixed housing in this embodiment may refer to an outer housing of the dental nurse workbench. Based on the setting of the adapter 13, when cleaning and sewage discharge operations are needed, the liquid inlet end of the saliva suction assembly 3 may be quickly and conveniently connected to the external liquid supply pipeline 102 (specifically, it may be connected to the external tap water supply 1023 and/or the liquid supply end of the cleaning container 101). The specific structure of the quick-connect interface may be referred to the prior art, and will not be repeated here.

In an embodiment, a movably connected valve core is arranged in an inner cavity of the adapter 13. When the valve core is in an open position, the inner cavity of the adapter 13 is in a conducting state. When the valve core is in a closed position, the inner cavity of the adapter 13 is in a cut-off state. When the liquid inlet end of the saliva suction assembly 3 is plugged into a first end of the adapter 13, the liquid inlet end of the saliva suction assembly 3 is configured to push the valve core from the closed position to the open position. Based on this setting, it is possible to prevent the adapter 13 from being conductive in an unconnected state, thereby causing internal liquid leakage, and it also prevents external contaminants from entering the corresponding pipeline through the adapter 13, which could pollute the cleaning liquid or cause blockages in the pipeline.

In an embodiment, referring to FIG. 3 and FIG. 4, a sewage discharge end of the sewage container 4 is connected to a sewage discharge pipe 9, a second valve 10 is arranged in the sewage discharge pipe 9, a second trigger switch 11 is arranged at the sewage discharge pipe 9, and the second trigger switch 11 is electrically connected to the second valve 10.

When the second trigger switch 11 changes from a state of not being affected by an external action to a state of being affected by the external action, the second trigger switch 11 is configured to send a second closing signal to the second valve 10. When the second trigger switch 11 changes from a state of being affected by an external action to a state of not being affected by the external action, the second trigger switch 11 is configured to send a third opening signal to the second valve 10.

The second valve 10 is configured to close when receiving the second closing signal, and the second valve 10 is configured to open when receiving the third opening signal.

In practical applications, the discharge pipe 9 typically needs to be hung on the hanger on the dental nurse's workstation after the sewage discharge is completed. Based on this usage scenario, by arranging the second trigger switch 11 at the discharge pipe 9, the interaction between the second trigger switch 11 and the hanger may automatically trigger the second valve 10 to open or close, thereby automatically starting the sewage discharge operation after the sewage discharge pipe 9 is removed from the hanger, and automatically stopping the sewage discharge operation after the sewage discharge pipe 9 is hung on the hanger, thereby improving the automation and intelligence level of the devices.

Specifically, the second trigger switch 11 may be a contact switch, a pressure-sensitive sensor, a photoelectric switch, or other sensing devices that may be triggered by external forces. The external force may refer to the second trigger switch 11 being subjected to a certain external force, the distance between the second trigger switch 11 and the target device reaching a preset threshold, or the light emitted by the second trigger switch 11 being blocked by the target device, ect. Taking the first trigger switch 8 implemented as a pressure-sensitive sensor as an example, the press may be arranged at the contact point between the sewage discharge pipe 9 and the hanger. When the sewage discharge is completed and the sewage discharge pipe 9 is hung on the hanger, the press is compressed and rotated by a certain angle. At this point, the press transitions from a state of not being affected by an external action to a state of being affected by the external action, sending the third trigger signal to the main control module 7, thereby triggering the second valve 10 to close and stop the sewage discharge. When a sewage discharge operation is needed, the sewage discharge pipe 9 is removed from the hanger, so that the elastic press is no longer compressed and returns to its original angle. In this case, the press transitions from a state of being affected by an external action to a state of not being affected by the external action, sending the third opening signal to the main control module 7, thereby automatically triggering the opening of the second valve 10 and start the sewage discharge.

Referring to FIG. 3 and FIG. 5, the present application provides a dental nurse workbench, the dental nurse workbench includes the workbench waterway integrated system in any of the above embodiments.

The dental nurse workbench provided in this embodiment is configured to treat various types of sewage generated during operations such as dental implantation. Since the dental nurse workbench adopts all the technical solutions of all the above embodiments, it has at least all the beneficial effects brought by the technical solutions of the above embodiments, that is, through the rational arrangement of the cleaning assembly 1, the spittoon 2, the saliva suction assembly 3 and the sewage container 4, through the rational arrangement of the connection pipes between the sewage container 4, the spittoon 2, the cleaning container 101, and the first conveying assembly 5 and the second conveying assembly 6 may be configured to transfer the liquid between the devices to orderly complete a series of tasks such as unified collection of sewage, cleaning of devices, and centralized sewage discharge, and the operations do not interfere with each other, thereby improving the sewage discharge efficiency and reducing the risk of direct contact healthcare workers and harmful substances in the sewage.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A workbench control assembly, comprising:
a cleaning assembly configured to supply a cleaning liquid;
a spittoon connected to the cleaning assembly, wherein the spittoon is configured to receive mouth rinse wastewater;
a saliva suction assembly configured to contact oral sewage or connect to the cleaning assembly;
a sewage container connected to the spittoon and the saliva suction assembly;
a first conveying assembly connected to the cleaning assembly, wherein when the saliva suction assembly is connected to the cleaning assembly, the first conveying assembly is configured to convey the cleaning liquid supplied by the cleaning assembly to the spittoon and the saliva suction assembly respectively; and
a second conveying assembly connected to the sewage container, wherein when the saliva suction assembly contacts the oral sewage, the second conveying assembly is configured to convey the oral sewage at the saliva suction assembly to the sewage container, and when the saliva suction assembly is connected to the cleaning assembly, the second conveying assembly is configured to convey a mixed liquid conveyed to the spittoon and the saliva suction assembly to the sewage container.

2. The workbench control assembly according to claim 1, wherein the cleaning assembly comprises a cleaning container and an external liquid supply pipeline, the cleaning container is in communication with the external liquid supply pipeline, the cleaning container is connected to the spittoon, the saliva suction assembly is in communication with the external liquid supply pipeline, and the cleaning container is configured to store the cleaning liquid.

3. The workbench control assembly according to claim 2, wherein the external liquid supply pipeline comprises a first pipe and a second pipe, a first end of the first pipe is connected to an external tap water supply, a second end of the first pipe is in communication with the cleaning container, a first end of the second pipe is connected to the external tap water supply and/or the cleaning container, and a second end of the second pipe is connected to the saliva suction assembly.

4. The workbench control assembly according to claim 2, wherein:
the cleaning container is connected to the spittoon through a first suction pump, and a first valve is arranged at a connecting channel between the spittoon and the sewage container;
the workbench control assembly further comprises a main control module, the main control module is electrically connected to the first suction pump and the first valve;
the main control module is configured to simultaneously send a first opening signal to the first suction pump and the first valve when receiving an external sewage discharge instruction;
the first suction pump is configured to perform a suction operation to suck the cleaning liquid in the cleaning container into the spittoon when receiving the first opening signal; and
the first valve is configured to open when receiving the first opening signal.

5. The workbench control assembly according to claim 1, wherein:
the saliva suction assembly is provided with a first trigger switch, the workbench control assembly further comprises a main control module, the main control module is electrically connected to the first trigger switch and the second conveying assembly;
when the first trigger switch changes from a state of not being affected by an external action to a state of being affected by the external action, the first trigger switch is configured to send a first trigger signal to the main control module, or when the first trigger switch changes from a state of being affected by an external action to a state of not being affected by the external action, the first trigger switch is configured to send a second trigger signal to the main control module;
the main control module is configured to send a first stop signal to the second conveying assembly when receiving the first trigger signal, and the main control module is configured to send a first start signal to the second conveying assembly when receiving the second trigger signal; and
the second conveying assembly is configured to stop conveying the oral sewage at the saliva suction assembly to the sewage container when receiving the first stop signal, and the second conveying assembly is configured to start conveying the oral sewage at the saliva suction assembly to the sewage container when receiving the first start signal.

6. The workbench control assembly according to claim 5, wherein:
the sewage container is provided with a water volume sensing device electrically connected to the main control module;
the main control module is configured to send a water volume detection signal to the water volume sensing device when receiving the second trigger signal;
the water volume sensing device is configured to start obtaining a real-time sewage volume in the sewage container when receiving the water volume detection signal, and the water volume sensing device is configured to send a water volume indication signal to the main control module when the real-time sewage volume reaches a preset water volume threshold;
the main control module is configured to perform an alarm operation or send a second stop signal to the second conveying assembly when receiving the water volume indication signal; and
the second conveying assembly is configured to stop conveying the oral sewage at the saliva suction assembly to the sewage container when receiving the second stop signal.

7. The workbench control assembly according to claim 5, wherein:
the sewage container is provided with a pressure sensing device electrically connected to the main control module;
the main control module is configured to send a pressure detection signal to the pressure sensing device when receiving the second trigger signal;
the pressure sensing device is configured to start obtaining a negative pressure value in the sewage container when receiving the pressure detection signal, and the pressure sensing device is configured to send a pressure indication signal to the main control module when the negative pressure value reaches a preset pressure threshold;
the main control module is configured to perform an alarm operation or send a third stop signal to the second conveying assembly when receiving the pressure indication signal; and
the second conveying assembly is configured to stop conveying the oral sewage at the saliva suction assembly to the sewage container when receiving the third stop signal.

8. The workbench control assembly according to claim 5, wherein:
a sewage discharge end of the sewage container is connected to a sewage discharge pipe, a second valve is arranged in the sewage discharge pipe, a second trigger switch is arranged at the sewage discharge pipe, and the main control module is electrically connected to the second valve and the second trigger switch;
when the second trigger switch changes from a state of not being affected by an external action to a state of being affected by the external action, the second trigger switch is configured to send a third trigger signal to the main control module, or when the second trigger switch changes from a state of being affected by an external action to a state of not being affected by the external action, the second trigger switch is configured to send a fourth trigger signal to the main control module;
the main control module is configured to send a first closing signal to the second valve when receiving the third trigger signal, and the main control module is configured to send a second opening signal to the second valve when receiving the fourth trigger signal; and
the second valve is configured to close when receiving the first closing signal, and the second valve is configured to open when receiving the second opening signal.

9. The workbench control assembly according to claim 8, wherein the main control module is configured to send a second closing signal to the second valve when receiving the second trigger signal, and the second valve is configured to close when receiving the second closing signal.

10. A workbench waterway integrated system, comprising:
a sewage container, wherein a sewage discharge end of the sewage container is in communication with an external sewage discharge area;
a spittoon configured to receive mouth rinse wastewater, wherein a liquid discharge port of the spittoon is in communication with a first liquid collection end of the sewage container;
a cleaning container, wherein a replenishment end of the cleaning container is in communication with an external liquid supply pipeline, a liquid supply end of the cleaning container is in communication with a liquid inlet of the spittoon, and the cleaning container is configured to supply a cleaning liquid to the spittoon to clean the spittoon; and
a saliva suction assembly, wherein a liquid discharge end of the saliva suction assembly is in communication with a second liquid collection end of the sewage container, and a liquid inlet end of the saliva suction assembly is configured to suck oral sewage or to be in communication with the external liquid supply pipeline.

11. The workbench waterway integrated system according to claim 10, wherein:
a plurality of the liquid inlets are arranged at the spittoon, the plurality of the liquid inlets are circumferentially arranged around an upper side of the spittoon, and the liquid discharge port is arranged at a bottom of the spittoon; and/or
the saliva suction assembly comprises a strong tip and a weak tip, and the workbench waterway integrated system further comprises a tee fitting, a first connection end of the tee fitting is in communication with the strong tip, a second connection end of the tee fitting is in communication with the weak tip, and a third connection end of the tee fitting is in communication with the second liquid collection end of the sewage container.

12. The workbench waterway integrated system according to claim 10, wherein the external liquid supply pipeline comprises a first pipe and a second pipe, a first end of the first pipe is connected to an external tap water supply, a second end of the first pipe is in communication with the replenishment end of the cleaning container, a first end of the second pipe is connected to the external tap water supply and/or the liquid supply end of the cleaning container, and a second end of the second pipe is in communication with a liquid inlet end of the saliva suction assembly.

13. The workbench waterway integrated system according to claim 10, further comprising:
a negative pressure assembly,
wherein the negative pressure assembly is in communication with a negative pressure end of the sewage container, the negative pressure assembly is configured to generate a negative pressure inside the sewage container, so as to uniformly suck external mixed liquid into an inner cavity of the sewage container through the first liquid collection end and the second liquid collection end.

14. The workbench waterway integrated system according to claim 13, wherein:
the saliva suction assembly is provided with a first trigger switch electrically connected to the negative pressure assembly;
when the first trigger switch changes from a state of not being affected by an external action to a state of being affected by the external action, the first trigger switch is configured to send a first closing signal to the negative pressure assembly, or when the first trigger switch changes from a state of being affected by an external action to a state of not being affected by the external action, the first trigger switch is configured to send a first opening signal to the negative pressure assembly; and
the negative pressure assembly is configured to exit a negative pressure working state when receiving the first closing signal, and the negative pressure assembly is configured to enter the negative pressure working state when receiving the first opening signal.

15. The workbench waterway integrated system according to claim 13, wherein:
the sewage container is provided with a water volume sensing device electrically connected to the negative pressure assembly;
the water volume sensing device is configured to obtain a real-time sewage volume in the sewage container, and the water volume sensing device is configured to send a stop signal to the negative pressure assembly when the real-time sewage volume reaches a preset water volume threshold; and
the negative pressure assembly is configured to stop the negative pressure operation when receiving the stop signal.

16. The workbench waterway integrated system according to claim 15, wherein:
the liquid supply end of the cleaning container is connected to the liquid inlet of the spittoon through a first suction pump, and a first valve is arranged at a connection pipe between the liquid discharge port of the spittoon and the first liquid collection end of the sewage container;
the workbench waterway integrated system further comprises a control switch, the control switch is electrically connected to the first suction pump and the first valve;
the control switch is configured to simultaneously send a second opening signal to the first suction pump and the first valve when receiving an external sewage discharge instruction;
the first suction pump is configured to perform a suction operation to suck the cleaning liquid in the cleaning container into the spittoon when receiving the second opening signal; and
the first valve is configured to open when receiving the second opening signal.

17. The workbench waterway integrated system according to claim 10, further comprising:
an adapter,
wherein the adapter is configured to lock on a fixed housing, a first end of the adapter forms a quick-connect interface, the liquid inlet end of the saliva suction assembly is configured to be plugged into a first end of the adapter, and a second end of the adapter is in communication with the external liquid supply pipeline.

18. The workbench waterway integrated system according to claim 10, wherein:
a sewage discharge end of the sewage container is connected to a sewage discharge pipe, a second valve is arranged in the sewage discharge pipe, a second trigger switch is arranged at the sewage discharge pipe, and the second trigger switch is electrically connected to the second valve;
when the second trigger switch changes from a state of not being affected by an external action to a state of being affected by the external action, the second trigger switch is configured to send a second closing signal to the second valve, or when the second trigger switch changes from a state of being affected by an external action to a state of not being affected by the external action, the second trigger switch is configured to send a third opening signal to the second valve; and
the second valve is configured to close when receiving the second closing signal, and the second valve is configured to open when receiving the third opening signal.

19. A dental nurse workbench, comprising:
the workbench control assembly according to claim 1.

20. A dental nurse workbench, comprising:
the workbench waterway integrated system according to claim 10.
